(19) United States
(12) Patent Application Publication
(10) Pub. No.: US 2015/0356964 A1
(43) Pub. Date: Dec. 10, 2015

(54) AUDIO SIGNAL PROCESSING CIRCUIT AND ELECTRONIC DEVICE USING THE SAME

(71) Applicant: ROHM CO., LTD., Ukyo-ku (JP)

(72) Inventors: Katsuyuki ONO, Ukyo-ku (JP); Shinji YAMAGAMI, Ukyo-ku (JP)

(21) Appl. No.: 14/730,747

(22) Filed: Jun. 4, 2015

(30) Foreign Application Priority Data
Jun. 9, 2014 (JP) 2014-118961

(51) Int. Cl. G10K 11/175

(52) U.S. Cl. CPC G10K 11/175

(57) ABSTRACT

An audio signal processing circuit and an electronic device are provided. A noise detection circuit determines if the first input audio signal and a second input audio signal contain noise. The noise cancellation circuit (i), when no noise is detected, outputs a first intermediate audio signal corresponding to the first input audio signal and a second intermediate audio signal corresponding to the second input audio signal without detected noise; (ii) when noise is detected, generates a third intermediate audio signal after performing a specific noise modification process upon the first input audio signal and the second input audio signal, and outputs the first intermediate audio signal including the third input audio signal and the second intermediate audio signal including the third input audio signal. A beamforming circuit performs a beamforming process according to a differential signal of the first intermediate audio signal and the second intermediate audio signal.

### CROSS REFERENCE TO RELATED APPLICATIONS

The present invention claims priority under 35 U.S.C. §119 to Japanese Application No. 2014-118961 filed Jun. 9, 2014, the entire content of which is incorporated herein by reference.

### FIELD OF THE INVENTION

The present invention relates to an audio signal processing circuit.

### BACKGROUND

For electronic devices such as digital camcorders, digital cameras, mobile phones, laptop notebooks, car navigation systems, and headsets, the functions of voice recording or voice communication can be installed thereon. To improve the directivity of the recording quality of an audio signal generated by a signal source from a specific direction, a beamforming technique is developed. The beamforming technique is capable of recording the target audio signal transmitted from a specific direction and removing the unwanted audio signals transmitted from other directions.

FIGS. 1A˜1C are diagrams illustrating the beamforming technique. The audio recording system 1r comprises a signal processing circuit 10 and microphones 12a, 12b. The microphones 12a, 12b are non-directional microphones, which are installed along the directional axis 14 and are separated by a specific distance.

The signal processing circuit 10 receives the audio signals S1a and S1b in the form of electrical signals which are received and converted by the microphones 12a, 12b respectively. The audio signal processing circuit 10 comprises a delay element 11 for delaying the audio signal S1b. For clearly recording the audio signal, the audio signal processing circuit 10 performs the beamforming process to extract the target audio signal from the direction of the center of the directional axis 14. The delay amount T of the delay component 11 is set by the value such that the detecting voltage level corresponding to the audio signal in the opposite direction of the directional axis 14 is substantially zero. Since the beamforming technique is well known to those skilled in the art, the following paragraphs are the brief description of the beamforming technique and the detailed description is omitted for brevity.

FIG. 1A illustrates a circumstance where an audio source 2 has a direction the same as the directional axis 14. FIG. 1B illustrates a circumstance where the audio source 2 has a direction perpendicular to the directional axis 14. FIG. 1B illustrates a circumstance where the audio source 2 has a direction opposite to the directional axis 14. FIGS. 2A˜2C illustrate the waveforms of the audio signals obtained in FIGS. 1A˜1C respectively. For the sake of description, the horizontal and vertical axes of the waveforms or timing diagrams in the specification are adaptively enlarged or reduced. In addition, the waveforms are also being simplified or emphasized for the sake of description.

The two microphones 12a and 12b are only separated by a few centimeters. Therefore, the sound signals 4 generated by the audio source 2 almost have the same amplitude when the sound signals 4 are inputted into the two microphones 12a and 12b, and their phase difference Δφ is varied according to the direction of the audio source 2. As shown in FIG. 1A, when the direction of the audio source 2 is the same as the directional axis 14, the phase difference of the two audio signals S1a and S1b is increased. On the other hand, as shown in FIG. 1B, when the direction 16 of the audio source 2 is perpendicular to the directional axis 14, the phase difference of the two audio signals S1a and S1b is close to zero.

The gain difference (amplitude difference) and/or phase difference of the audio signals S1a and S1b outputted from the microphones 12a and 12b can be used in the beamforming technique. When the two waveforms are the same, the gain difference or the phase difference are essentially equivalent, and the difference (S1a-S1b) of the two audio signals S1a and S1b is correlated. Hence, the audio signal processing circuit 10 can collect the sound signal 4 transmitted from the directional axis 14 by processing the differential signal (S1a-S1b).

### BACKGROUND TECHNICAL LITERATURE

### Patent Literatures

[Patent literature 1] International patent publication number 09/025090

[Patent literature 2] International patent publication 09/044562

### BRIEF SUMMARY OF THE INVENTION

### Problem to be Solved in the Present Invention

The following problems are discovered after studying the high directivity audio recording system 1r by using the beamforming technique.

For example, when the audio recording electronic device is used with an Electret Condenser Microphone (ECM) under windy conditions, the vibrating plate in the ECM will physically vibrate due to the sound of the wind. As a result, noises from the wind are also recorded. However, noise signals mixed with the two audio signal inputs S1a and S1b will significantly disturb the gain/phase difference. Consequently, the beamforming process is also affected. The disturbance of gain/phase difference not only deteriorates noise in the noise frequency band, but also leads to significant noise from the noise frequency bands. The audio recording system will face a similar problem when using the recording system in any vibrating environment.

It is noted that the above problem is discovered by the inventors of this invention, and the problem is not a general problem faced by those skilled in the art.

Accordingly, this invention is provided to solve the above-mentioned problem. One of the objectives of the present embodiment is to provide an audio signal processing circuit capable of reducing the impact of noise.

### Technical Solution

According to an embodiment of the present invention, the embodiment provides an audio signal processing circuit applicable for processing a first input audio signal and a second input audio signal received from a first microphone and a second microphone respectively. The audio signal processing circuit comprises: a noise detection circuit for determining if the first input audio signal and the second input audio signal contain noise higher than a tolerance noise level, wherein when the first input audio signal and the second input audio signal contain the noise, the noise detection circuit detects the noise and generates a noise detection signal; a noise cancellation circuit, wherein (i) when the noise detection signal is negated, the noise cancellation circuit outputs a first intermediate audio signal corresponding to the first input audio signal and a second intermediate audio signal corresponding to the second input audio signal, (ii) when the noise detection signal is affirmed, the noise cancellation circuit generates a third intermediate audio signal after performing a specific noise modification process upon the first input audio signal and the second input audio signal, and outputs the first intermediate audio signal comprising the third input audio signal, and the second intermediate audio signal comprising the third input audio signal; and a beamforming circuit for receiving the first intermediate audio signal and the second intermediate audio signal outputted from the noise cancellation circuit, and performing a beamforming process in accordance with a differential signal between the first intermediate audio signal and the second intermediate audio signal.

According to the embodiment, when the noise occurs, the noise impact can be reduced by replacing the first intermediate audio signal and the second intermediate audio signal with the third intermediate audio signal, and by providing the generated signal to the subsequent beamforming circuit.

The noise cancellation circuit performs the noise modification process targeting at each specific frequency band of the first input audio signal and the second input audio signal.

Accordingly, the embodiment can preserve the directivity of the frequency bands other than the targeting noise modification frequency bands.

The noise cancellation circuit further comprises a filter for dividing the first input audio signal and the second input audio signal into a plurality of frequency bands respectively.

The noise cancellation circuit performs the following operations: (i) when the noise detection signal is negated, the noise cancellation circuit combines the plurality of frequency bands divided from the first input audio signal, and outputs the first intermediate audio signal corresponding to the combined signal of the plurality of frequency bands divided from the first input audio signal, and combines the plurality of frequency bands divided from the second input audio signal, and outputs the second intermediate audio signal corresponding to the combined signal of the plurality of frequency bands divided from the second input audio signal; and (ii) when the noise detection signal is affirmed, the noise cancellation circuit performs the noise modification process upon a target modifying frequency band in the plurality of frequency bands of the first input audio signal and the target modifying frequency band of the second input audio signal to generate the third intermediate audio signal, and generates the first intermediate audio signal by combining the third input audio signal and other frequency bands of the first input audio signal, and further generates the second intermediate audio signal by combining the third input audio signal and other frequency bands of the second input audio signal.

The target modifying frequency band of the noise cancellation circuit comprises a frequency band of 0˜500 Hz.

Therefore, the noise induced by wind or vibration can be significantly reduced.

The noise cancellation circuit performs the noise modification process targeting at all frequency bands of the first input audio signal and the second input audio signal.

The noise modification process comprises a process of computing an average value of two target modifying signals.

The average value is an unweighted average value of the two target modifying signals.

The average value can also be a weighted average value of the two target modifying signals.

Accordingly, by adjusting the values of the weighting factors, the relation between the noise reduction effect and the directivity can be optimized.

The weighting factor for a larger signal in the two target modifying signals may be less than the one for a smaller signal in the two target modifying signals.

For the two target modifying signals, the voltage level of the signal having the higher voltage level is more likely caused by the wind noise. Thus, by setting a larger weighting factor for the signal having the smaller voltage level, the target sound can dominate the output signal and the noise is reduced.

The noise modification process further comprises at least one of a process of multiplying the two target modifying signals by a specific factor or a process of multiplying the average value by the specific factor.

The specific factor is adjusted in accordance with the voltage level of the detected noise signal.

According to another embodiment of the present invention, the embodiment provides an audio signal processing circuit applicable for processing a first input audio signal and a second input audio signal received from a first microphone and a second microphone respectively. The audio signal processing circuit comprises: a filter for dividing the first input audio signal and the second input audio signal into a plurality of frequency bands respectively; a noise detection circuit for determining if the first input audio signal and the second input audio signal contain noise higher than a tolerance noise level, wherein when the first input audio signal and the second input audio signal contain the noise, the noise detection circuit detects the noise and generates a noise detection signal; and a beamforming circuit, wherein (i) when the noise detection signal is negated, the beamforming circuit performs a beamforming process targeting at all frequency bands of the first input audio signal and the second input audio signal; (ii) when the noise detection signal is affirmed, the beamforming circuit discards each target modifying frequency band of the first input audio signal and the second input audio signal, and performs the beamforming process upon the remaining frequency bands.

According to the embodiment, the noise disturbance of the differential signal of the gain/phase difference can be avoided during the beamforming process. Therefore, the noise is reduced.

An embodiment further comprises: a first amplifier for amplifying an output signal of the first microphone; a second amplifier for amplifying the output signal of the second microphone; a first A/D converter for converting the output signal of the first amplifier into the first input audio signal in digital format; and a second A/D converter for converting the output signal of the second amplifier into the second input audio signal in digital format.

In one embodiment, the audio signal processing circuit is integrated as a chip on a semiconductor substrate. The chip may comprise all of the required components of the audio signal processing circuit, or just comprise the main components of the audio signal processing circuit. In practice, partial resistors or capacitors can be installed external to the semiconductor substrate for the sake of adjustment.

Another embodiment of the present invention is an electronic device. The electronic device comprises a first channel microphone, a second channel microphone, and one of the above-mentioned audio signal processing circuits.

Those skilled in the art may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

### Effects of the Present Invention

According to the audio signal processing circuit of the present invention, the noise is suppressed.

### BRIEF DESCRIPTION OF THE DRAWINGS

FIGS. 1A˜1C are diagrams illustrating the beamforming process.

FIG. 2A˜2C are diagrams illustrating the waveforms of the audio signals obtained in FIGS. 1A˜1C respectively.

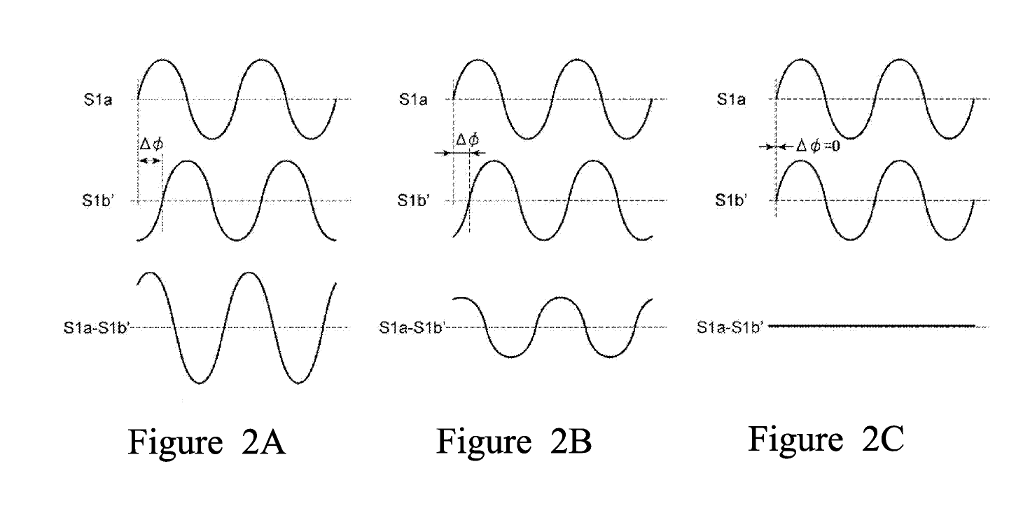

FIG. 3 is a block diagram illustrating an audio recording system having an audio signal processing circuit according to a first embodiment

FIG. 4 is a diagram illustrating a noise cancellation circuit.

FIG. 5 is a diagram illustrating spectrums of audio signals obtained by an audio signal processing circuit.

FIG. 6 is a diagram illustrating an audio recording system comprising an audio signal processing circuit according to a second embodiment.

FIG. 7 is a cross-sectional diagram illustrating an electronic device using an audio signal processing circuit.

### DETAILED DESCRIPTION

The details of one or more embodiments of the disclosure are set forth in the accompanying drawings and the description below. The present disclosure may repeat reference numerals and/or letters in the various examples. This repetition is for the purpose of simplicity and clarity and does not in itself dictate a relationship between the various embodiments and/or configurations discussed. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

It will be understood that when an element A is referred to as being “connected to” or “coupled to” another element B, it may be directly connected to or coupled to the other element, or intervening elements may be present.

Similarly, when an element C is referred to as being “connected between” or “coupled between” an element A and another element B, it may be directly connected between or coupled between the element A and the element B, or intervening elements may be present.

### The First Embodiment

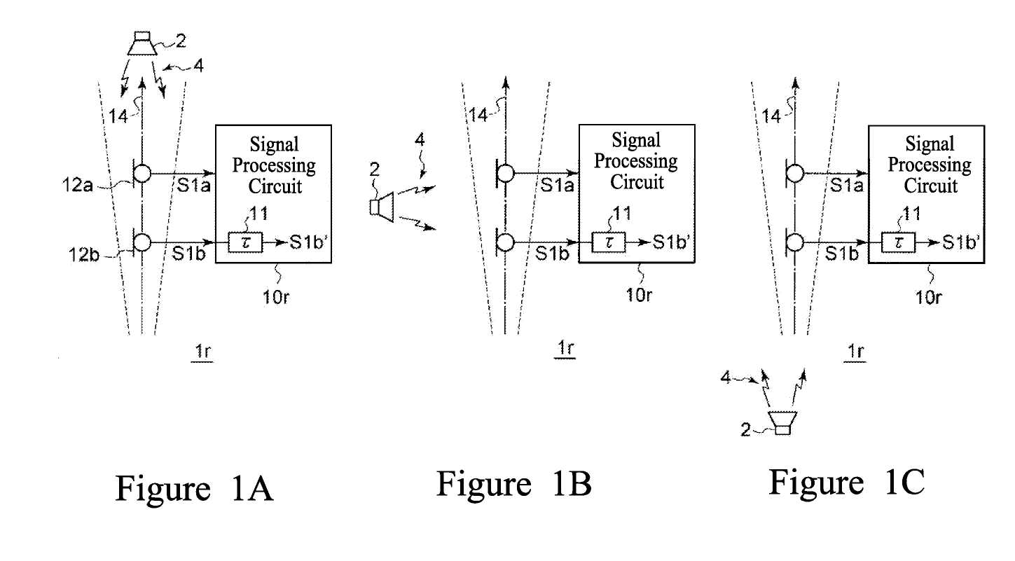

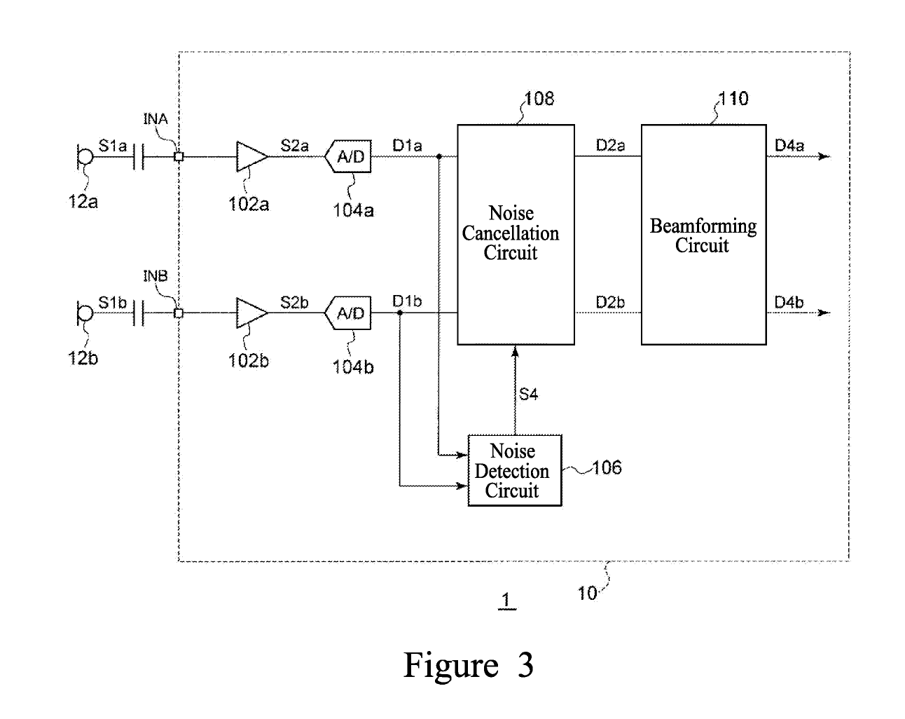

FIG. 3 is a block diagram illustrating an audio recording system 1 having an audio signal processing circuit 10 according to a first embodiment. The audio recording system 1 comprises the audio signal processing circuit 10, a first microphone 12a, and a second microphone 12b. Similar to those in FIGS. 1A and 1B, the first microphone 12a and the second microphone 12b are non-directional microphones, and the first microphone 12a and the second microphone 12b are installed on the directional axis 14 and separated by a specific distance.

The audio signal processing circuit 10 receives the audio signals S1a and S1b, which are converted into the electrical signals by the first microphone 12a and the second microphone 12b respectively. In addition, for clearly recording the audio signal, the audio signal processing circuit 10 performs the beamforming process to extract the targeting audio signal from the direction of the center of the directional axis.

The audio signal processing circuit 10 comprises a first amplifier 102a, a second amplifier 102b, a first A/D converter 104a, a second A/D converter 104b, a noise detection circuit 106, a noise cancellation circuit 108, and a beamforming circuit 110. The components of the audio signal processing circuit 10 are integrated into a functional integrated circuit (IC) on a semiconductor substrate. In additional, the audio signal processing circuit 10 further comprises a microphone bias voltage circuit (not shown) for providing the bias voltages to the first microphone 12a and the second microphone 12b.

The input terminals INA and INB of the audio signal processing circuit 10 are connected to the first microphone 12a and the second microphone 12b via direct current (DC) isolating capacitors C1a and C2b, and the input terminals INA and INB receive the analog audio signals S1a and S1b from the first microphone 12a and the second microphone 12b.

The first amplifier 102a and the second amplifier 102b amplify the analog audio signals S1a and S1b respectively. The first A/D converter 104a and the second A/D converter 104b are arranged to convert the analog audio signals S2a and S2b outputted from the first amplifier 102a and the second amplifier 102b into digital audio signals D1a and D1b respectively. The audio signals D1a and D1b are the first input audio signal and the second input audio signal respectively.

The noise detection circuit 106 receives the first input audio signal D1a and the second input audio signal D1b, determines if the audio signals S1a and S1b contain noise higher than a tolerance noise level, and generates a noise detection signal S4 indicating the detection result. For example, if the noise is detected, the noise detection circuit 106 asserts the noise detection signal S4 (e.g. a high voltage level). The embodiment does not limit the method of detecting the noise. For example, the method published in Japan patent publication 2014-060525 or any other technique can be used to detect the noise. The low frequency noise, which is induced by wind or vibration, is the preferred noise target to be detected. Specifically, the frequency band of the noise may be ranged from 0˜300 Hz, 0˜500 Hz, or 0˜1 KHz. However, this is not a limitation of the embodiment.

The noise detection circuit 108 receives the first input audio signal D1a and the second input audio signal D1b, and outputs a first intermediate audio signal D2a and a second intermediate audio signal D2b.

When the noise detection signal S4 is negated, i.e. when the noise detection circuit 106 does not detect a noise higher than the tolerance noise level, the noise cancellation circuit 108 outputs the first intermediate audio signal D2a corresponding to the first input audio signal D1a and the second intermediate audio signal D2b corresponding to the second input audio signal D1b.

For example, when D2a=D1a and D2b=D1b, the noise detection signal S4 is negated. Then, the noise cancellation circuit 108 can directly pass through the input audio signals D1a and D1b.

Alternatively, the noise cancellation circuit 108 can also use a predefined function f(x)=αx+β with predefined parameters of α and β to compute D1a and D1b for outputting D2a and D2b, i.e. D2a=f(D1a) and D2b=f(D1b).

When

the noise detection signal S4 is affirmed, i.e. when the noise detection circuit 106 detects a noise higher than the tolerance noise level, the noise cancellation circuit 108 outputs a third intermediate audio signal D3 by performing a specific noise modification process upon the first input audio signal D1a and the second input audio signal D2b. Then, the noise cancellation circuit 108 outputs the first intermediate audio signal D2a comprising the third intermediate audio signal D3, and outputs the second intermediate audio signal D2b comprising the third intermediate audio signal D3.

In the embodiment, the noise modification process is capable of removing the affection caused by the low frequency noise, such as the sound of wind. The noise modification process is capable of processing all frequency bands of the two signals D1a and D1b, or just processing a specific frequency band of noise caused by of the sound of wind or the vibration. The noise modification process is to reduce the affection of the gain difference (phase difference) caused by the noise in the beamforming circuit 110. Therefore, the noise modification process can also be regarded as a phase correction or gain correction process.

For example, the noise modification process comprises a process of computing an average value of the two target modifying signals D1a and D1b. The average value Y may be an unweighted average value of the two signals D1a and D1b.

Y=(D1a+D1b)/2 (1)

The noise cancellation circuit 108 may use the average value Y obtained in equation (1) as the third intermediate audio signal D3.

Alternatively, the noise cancellation circuit 108 may multiply the average value Y by a specific factor K to obtain a value Y′, and the value Y′ is outputted as the third intermediate audio signal D3.

D3=Y′=Y×K

In other words, the noise modification process may calculate the average value by the equation (1) after multiplying the two target modifying signals D1a and D1b by the specific factors K respectively. The noise modification process may also calculate the average value Y by equation (1) and then multiply the average value Y by the specific factor K.

The factor K can be a fixed value or a variable value. The factor K can be adjusted to have different values. For example, K can be set by K=½ when a weaker wind is detected, or K can be set by K=¼ when a stronger wind is detected. Thus, the factor K can be adjusted in accordance with the strength of wind. In other words, the factor K can be adjusted in accordance with the voltage level of the detected noise signal. Moreover, the factor K can also be adjusted in accordance with parameters other than the voltage level of a detected noise signal.

In addition, the noise modification process can also be the root mean square (RMS) process or other processes.

The beamforming circuit 110 receives the first intermediate audio signal D2a and the second intermediate audio signal D2b from the noise cancellation circuit 108, and performs the beamforming process at least according to the differential signal (d2a−D2b) of the first intermediate audio signal D2a and the second intermediate audio signal D2b. The beamforming process can be carried out by any well-known beamforming technique, and this is not a limitation of the present invention.

The output audio signals D4a and D4b after performing the beamforming process are further outputted to the following circuit, which is not shown in the figures. The following process for the beamforming circuit 110 is not a limitation of the embodiment. For example, the following process can be that of digital processes such as a filtering process, an equalizing process, a compressing process, and/or a coding process. The processed data is then stored into a storage device.

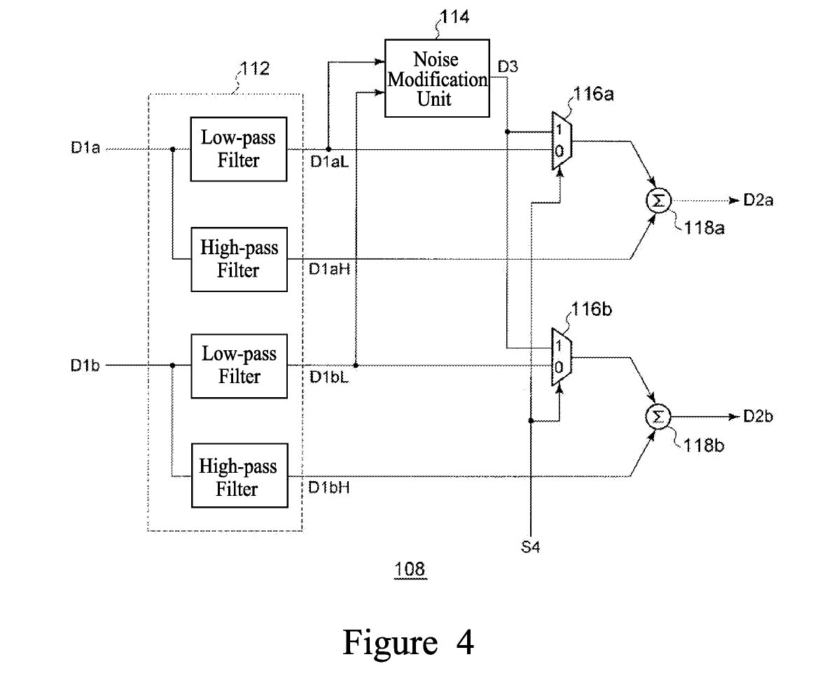

FIG. 4 is a functional diagram of the noise cancellation circuit 108. The noise cancellation circuit 108 performs the noise modification process on each specific frequency band (the targeting modification frequency band), which comprises the noise frequency, of the first input audio signal D1a and the second input audio signal D1b.

The noise cancellation circuit 108 comprises a filter 112. The filter 112 divides the first input audio signal D1a and the second input audio signal D1b into a plurality of frequency bands respectively. Furthermore, the first input audio signal D1a is divided into a high frequency component D1aH and a low frequency component D1aL by a low-pass filter and a high-pass filter. Similarly, the second input audio signal D1b is divided into a high frequency component D1bH and a low frequency component D1bL by a low-pass filter and a high-pass filter. The low frequency component can be regarded as the targeting modification frequency band.

When the noise detection signal S4 is negated (the low voltage level, 0), the noise cancellation circuit 108 combines the plurality of divided frequency bands D1aL and D1aH of the first input audio signal D1a, and outputs the first intermediate audio signal D2a corresponding to the combined signal. The combining process can also be an additive operation. In addition, the noise cancellation circuit 108 combines the plurality of divided frequency bands D1bL and D1bH of the second input audio signal D1b, and outputs the second intermediate audio signal D2b corresponding to the combined signal.

When the noise detection signal S4 is affirmed (the high voltage level, 1), the noise cancellation circuit 108 performs the noise modification process upon the targeting modification frequency band D1aL of the first intermediate audio signal D1a and the targeting modification frequency band D1bL of the second intermediate audio signal D1b for outputting the third intermediate audio signal D3. The noise cancellation circuit 108 also combines the third intermediate audio signal D3 with the other frequency bands D1aH of the first input audio signal D1a to generate the first intermediate audio signal D2a. Similarly, the noise cancellation circuit 108 also combines the third intermediate audio signal D3 with the other frequency bands D1bH of the second input audio signal D1b to generate the second intermediate audio signal D2b.

The above functions are carried out by the noise modification unit 114, the first selector 116a, the second selector 116b, the first combiner 118a, and the second combiner 118b.

The noise modification unit 114 receives the targeting modification frequency band D1aL of the first input audio signal D1a and the targeting modification frequency band D1bL of the second input audio signal D1b. Then, the noise modification unit 114 performs the specific noise modification process upon the targeting modification frequency bands to generate the third intermediate audio signal D3. The noise modification process, as described above, can be an unweighted averaging process. Therefore, the third intermediate audio signal D3 can be obtained by the following equation (2).

D3=(D1aL+D1bL)/2 (2)

The first selector 116a receives the third intermediate audio signal D3 and the targeting modification frequency band D1aL of the first input audio signal D1a. When the noise detection signal S4 is affirmed (i.e. 1), D3 is selected. When the noise detection signal S4 is negated, D1aL is selected. Similarly, the second selector 116b receives the third intermediate audio signal D3 and the targeting modification frequency band D1bL of the second input audio signal D1b. When the noise detection signal S4 is affirmed (i.e. 1), D3 is selected. When the noise detection signal S4 is negated, D1bL is selected.

The first combiner 118a adds up the output of the first selector 116a and the component D1aH of the first input audio signal D1a, but not the targeting modification frequency band. Similarly, the second combiner 118b adds up the output of the second selector 116b and the component D1bH of the second input audio signal D1b, but not the targeting modification frequency band.

In addition, the noise cancellation circuit 108 is not limited to the configuration of FIG. 4. Those skilled in the art will appreciated that other modified configurations may also perform the same function. For example, the first selector 116a and the second selector 116b can be omitted, and the operation of the noise modification unit 114 is switched by the noise detection signal S4. In another example: (i) when the noise detection signal S4 is affirmed, the noise modification unit 114 outputs the third intermediate audio signal D3 to the first combiner 118a and the second combiner 118b; (ii) when the noise detection signal S4 is negated, the noise modification unit 114 does not perform the noise modification process, and outputs D1aL and D1bL to the first combiner 118a and to the second combiner 118b respectively.

Moreover, the function of the noise modification unit 114 can be implemented by hardware or a combination of embedded processors and software.

The above paragraphs describe the configuration of the audio signal processing circuit 10. The operation of the audio signal processing circuit 10 where the noise is detected and the noise is not detected is described in the following paragraphs.

1. The Noise is not Detected

When the noise induced by the sound of wind or vibration is not present, the noise detection signal S4 is negated. Then, the noise cancellation circuit 108 allows the input signals D1a and D1b to pass through, and directly outputs the input signals D1a and D1b to the following beamforming circuit 110. In other words, the noise cancellation circuit 108 does not process the input audio signals. The beamforming circuit 110 receives the original input audio signals D1a and D1b to perform the beamforming process. Therefore, when the noise is not present, the operation is similar to the above-mentioned operation.

2. The Noise is Detected

When the noise induced by the sound of wind or vibration is present, the noise detection signal S4 of the noise detection circuit 106 is affirmed. Then, the noise cancellation circuit 108 performs the noise modification process targeting at each modification frequency band of the first input audio signal D1a and the second input audio signal D1b, and accordingly generates the third intermediate audio signal D3. It is noted that the other frequency bands are allowed to pass through the noise cancellation circuit 108.

The operation of the audio signal processing circuit 10 is described in the above paragraphs.

According to the audio signal processing circuit 10, in the targeting modification frequency band, the first intermediate audio signal D2a and the second intermediate audio signal D2b become the same component signal D3. As a result, the directivity is damaged. However, the differential signal (D2a-D2b) generated in the beamforming circuit 110 can be used to repair the effect of the sound of wind or vibration. In addition, for the frequency bands other than the targeting modification frequency band, the process is similar to the above-mentioned process. Therefore, the directivity of the other frequency bands can be preserved. In other words, when the noise is detected, the frequency band of the noise is discarded from the targets of the beamforming process.

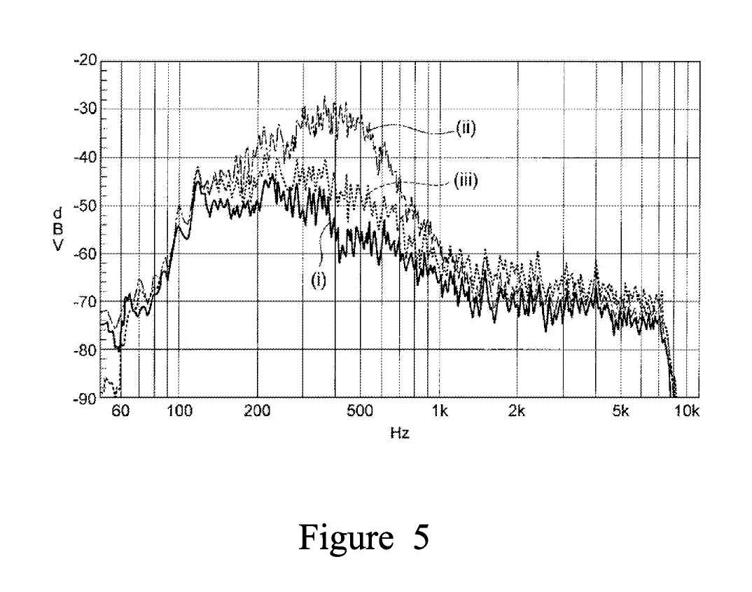

FIG. 5 is a diagram illustrating the spectrum of the audio signal D4a(D4b) obtained by the audio signal processing circuit 10 according to the embodiment. The spectrum is obtained by inputting the target audio signal 4 into the first microphone 12a and the second microphone 12b under the condition of a wind speed of 4.5 m/s. Meanwhile, a Fast Fourier Transform (FFT) is performed upon the acquired output audio signal D4a (D4b) to obtain the spectrum.

The curve (i) as shown in FIG. 5 is a spectrum obtained by the audio signal processing circuit 10 according to an embodiment. For the sake of comparison, the curve (ii) obtained by the beamforming process and the curve (iii) obtained by the beamforming process without performing the noise modification process in the audio signal processing circuit are shown in FIG. 5.

The spectrum of the curve (ii) of the audio signal processing circuit is equivalent to the result obtained by ignoring the detection result of the noise detection circuit 106, i.e. the result obtained by just negating the noise detection signal S4. The spectrum (iii) is obtained by just ignoring the noise detection signal S4 and disabling the beamforming circuit 110 to allow signals to pass through.

According to the comparison of the curves (ii) and (iii), if the beamforming process is performed under the condition of having a noise, such as the sound of wind, then the gain difference (phase difference) of the first intermediate audio signal D2a and the second intermediate audio signal D2b is affected significantly. Thus, the noise voltage in the frequency band of 100˜1 KHz is very large (i.e. (ii)). In addition, the noise voltage in the frequency band higher than 1 KHz is also seriously affected by the variation of the gain difference (phase difference).

On the contrary, although the beamforming process is performed in the embodiment, the curve (i) obtained by the audio signal processing circuit 10 can still reduce the noise voltage into a level lower than the level before performing the beamforming process, i.e. the curve (iii). It should be noted that the noise reduction process not only affects the targeting modification frequency band (0˜1 KHz) of the noise modification unit 114, but also affects other higher frequency bands.

A number of different variant embodiments of the first embodiment of the audio signal processing circuit 10 are described in the following paragraphs.

### First Variant Embodiment

In this embodiment, the noise modification process is an averaging process. Specifically, the averaging process is an unweighted averaging process. However, this is not a limitation of the present invention.

The average value Y may be a weighted average of the two signals D1a and D1b.

Y=(Ka×D1a+Kb×D1b)/(Ka+Kb) (3)

Ka and Kb are weighting factors.

If Ka+Kb=1, then the following equation (3′) can be obtained:

Y=(Ka×D1a+Kb×D1b) (3′)

By adjusting the values of the weighting factors Ka and Kb, the relation between the noise reduction effect and the directivity can be optimized. For example, the factors Ka and Kb can be set according to each of the signal voltage levels |D1a| and |D1b| of the first input audio signal D1a and the second input audio signal D1b respectively.

Specifically, for the two signals D1a and D1b (or D1aL and D1bL), the weighting factor for the signal having the larger signal voltage level is less than the weighting factor for the signal having the smaller signal voltage level.

When |D1a|>|D1b|, it is determined that the first input audio signal D1a has a larger wind noise. Then, under this circumstance, it can be concluded that the second input audio signal D1b has a higher ratio of target sound than the first input audio signal D1a. Thereafter, by setting Ka<Kb, the target sound in the second input audio signal D1b can dominate the extraction for generating the third intermediate audio signal D3. On the other hand, the setting is Ka>Kb if |D1a|<|D1b|.

### Second Variant Embodiment

In this embodiment, the first input audio signal D1a and the second input audio signal D1b are divided into two frequency bands respectively. However, this is not a limitation of the present invention. The first input audio signal D1a and the second input audio signal D1b can also be divided into three or more frequency bands respectively.

Moreover, in this embodiment, the noise cancellation circuit 108 only performs the noise cancellation process upon the specific targeting frequency band. However, this is not a limitation of the present invention. The noise cancellation circuit 108 can also perform the noise cancellation process upon all frequency bands.

### Third Variant Embodiment

In this embodiment, when the noise is detected, the low frequency component D2aL of the first intermediate audio signal D2a and the low frequency component D2bL of the second intermediate audio signal D2b become the same signal, i.e. the generation of the third intermediate audio signal D3. However, this is not a limitation of the present invention. The low frequency component D2aL of the first intermediate audio signal D2a and the low frequency component D2bL of the second intermediate audio signal D2b are not necessarily the same signal. As long as the signal contains at least the third intermediate audio signal D3, the signal belongs to the scope of the present invention. In addition, D2aL can be set as the sum up signal of D3 and the low frequency component D1aL of the first input audio signal D1a, and D2bL can be set as the sum up signal of D3 and the low frequency component D1bL of the second input audio signal D1b. In this circumstance, the directivity of the targeting modification frequency bands can be preserved.

### The Second Embodiment

In the first embodiment, when the noise is detected, each of the targeting modification frequency bands of the first intermediate audio signal D2a and the second intermediate audio signal D2b are replaced by the third intermediate audio signal D3. In other words, in the first embodiment, the frequency bands are discarded from the targeting modification frequency bands during the beamforming process of the beamforming circuit 110.

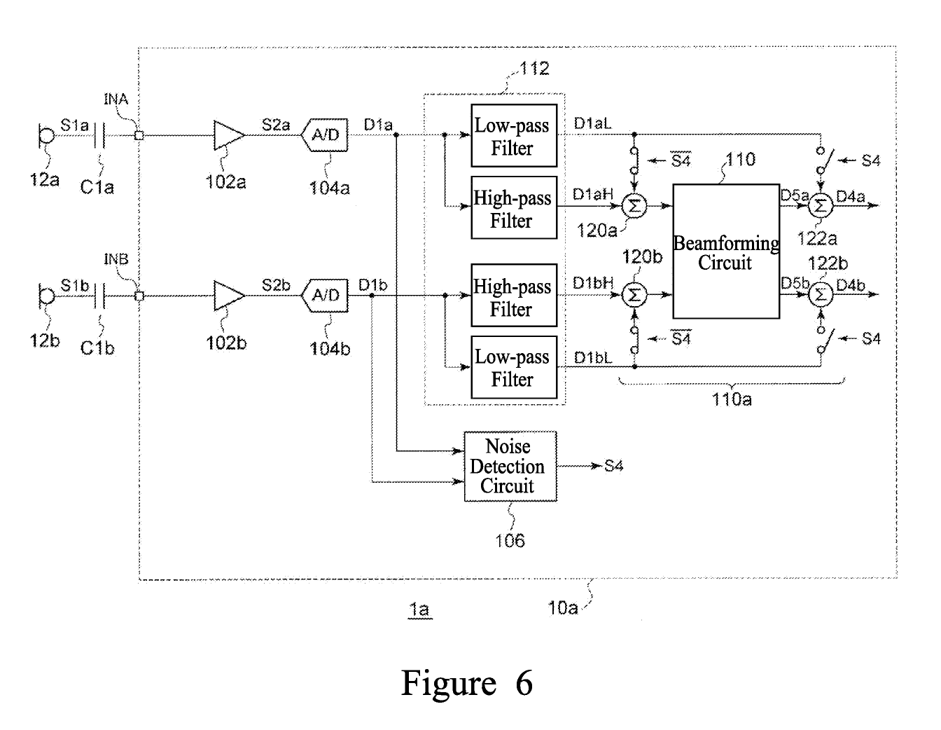

FIG. 6 is a block diagram illustrating an audio recording system comprising an audio signal processing circuit 10a according to the second embodiment. The audio signal processing circuit 10a comprises a first amplifier 102a, a second amplifier 102b, a first A/D converter 104a, a second A/D converter 104b, a noise detection circuit 106, a filter 112, and a beamforming circuit 110a.

The filter 112 divides the first input audio signal D1a and the second input audio signal D1b into a plurality of frequency bands respectively.

The noise detection circuit 106 determines if the first input audio signal D1a and the second input audio signal D1b contain noise higher than a tolerance noise level. The noise detection signal S4 is affirmed when the noise is present.

The beamforming circuit 110a (i) performs a beamforming process targeting all frequency bands of the first input audio signal D1a and the second input audio signal D1b when the noise detection signal S4 is negated. In addition, the beamforming circuit 110a (ii) discards each of the targeting modification frequency bands (the low frequency region) of the first intermediate audio signal D1a and the second intermediate audio signal D1b from the targeting frequency bands of the beamforming process when the noise detection signal S4 is affirmed, and performs the beamforming process upon the remaining frequency bands (the high frequency region).

The beamforming circuit 110a comprises a beamforming circuit 110, a third combiner 120a, a fourth combiner 120b, a fifth combiner 122a, and a sixth combiner 122b. The function of the beamforming circuit 110 is similar to the beamforming circuit 110 of FIG. 3.

When the noise detection signal S4 is negated, the third combiner 120a re-combines a plurality of frequency bands D1aL and D1aH of the first input audio signal D1a, which are divided by the filter 112, and outputs the combined signal to the beamforming circuit 110. When the noise detection signal S4 is affirmed, the third combiner 120a only outputs D1aH to the beamforming circuit 110.

Similarly, when the noise detection signal S4 is negated, the fourth combiner 120b re-combines a plurality of frequency bands D1bL and D1bH of the second input audio signal D1b, which are divided by a filter 112, and outputs the combined signal to the beamforming circuit 110. When the noise detection signal S4 is affirmed, the fourth combiner 120b only outputs D1bH to the beamforming circuit 110.

When the noise detection signal S4 is negated, the fifth combiner 122a directly outputs the output signal D5a of the beamforming circuit 110; and when the noise detection signal S4 is affirmed, the fifth combiner 122a combines the signal D1aL with the output signal D5a of the beamforming circuit 110.

Similarly, when the noise detection signal S4 is negated, the sixth combiner 122b directly outputs the output signal D5b of the beamforming circuit 110; when the noise detection signal S4 is affirmed, the sixth combiner 122b combines the signal D1bL with the output signal D5b of the beamforming circuit 110.

According to the operation of the audio signal processing circuit 10a, the similar effect of the first embodiment can be obtained.

Then, the application of the audio signal processing circuit 10 is described in the following paragraphs.

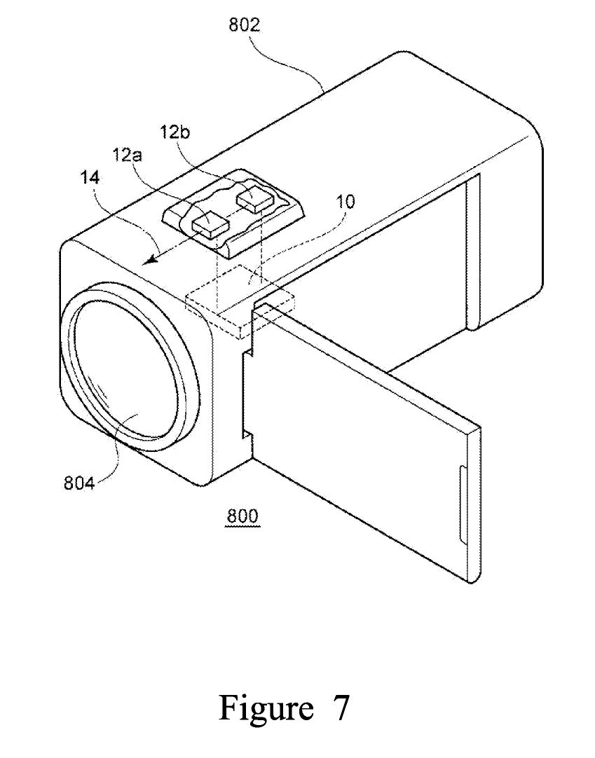

FIG. 7 is a cross-sectional diagram of an electronic device using the audio signal processing circuit 10. The electronic device in FIG. 7 is a digital camcorder, for example.

A digital camcorder 800 comprises a frame body 802, a lens 804, an image sensor (not shown), an image processor, and a storage media. In addition, the digital camcorder 800 further comprises a first microphone 12a, a second microphone 12b, and an audio signal processing circuit 10. The first microphone 12a and a second microphone 12b are installed along the directional axis 14.

In addition, the electronic equipment may also be a digital camcorder, an audio recorder, a mobile phone terminal, a smart phone, a personal handy-phone system (PHS), a personal hand-held phone system, a personal digital assistant (PDA), a laptop notebook, an input tablet terminal, an audio player, a car navigation system, a headset, or another device.

The present invention is described in accordance with a number of embodiments with clear context. Note that these embodiments simply represent the theory, principle, and application of the present invention. Those skilled in the art should also realize that there exist equivalent constructions and/or embodiments not departing from the spirit and scope of the present invention.

What is claimed is:

1. An audio signal processing circuit, applicable for processing a first input audio signal and a second input audio signal received from a first microphone and a second microphone respectively, the audio signal circuit comprising:
a noise detection circuit, for determining if the first input audio signal and the second input audio signal contain noise higher than a tolerance noise level, wherein when the first input audio signal and the second input audio signal contain the noise, the noise detection circuit detects the noise to generate a noise detection signal;
a noise cancellation circuit, wherein (i) when the noise detection signal is negated, the noise cancellation circuit outputs a first intermediate audio signal corresponding to the first input audio signal and a second intermediate audio signal corresponding to the second input audio signal; (ii) when the noise detection signal is affirmed, the noise cancellation circuit generates a third intermediate audio signal after performing a specific noise modification process upon the first input audio signal and the second input audio signal, and outputs the first intermediate audio signal comprising the third input audio signal, and the second intermediate audio signal comprising the third input audio signal; and
a beamforming circuit, for receiving the first intermediate audio signal and the second intermediate audio signal outputted from the noise cancellation circuit, and performing a beamforming process in accordance with a differential signal between the first intermediate audio signal and the second intermediate audio signal.

2. The audio signal processing circuit of claim 1, wherein:
the noise cancellation circuit performs the noise modification process targeting at each specific frequency band of the first input audio signal and the second input audio signal.

3. The audio signal processing circuit of claim 1, wherein:
the noise cancellation circuit further comprises a filter for dividing the first input audio signal and the second input audio signal into a plurality of frequency bands respectively.

4. The audio signal processing circuit of claim 3, wherein for the noise cancellation circuit:
(i) when the noise detection signal is negated, the noise cancellation circuit combines the plurality of frequency bands divided from the first input audio signal, and outputs the first intermediate audio signal corresponding to the combined signal of the plurality of frequency bands divided from the first input audio signal, and combines the plurality of frequency bands divided from the second input audio signal, and outputs the second intermediate audio signal corresponding to the combined signal of the plurality of frequency bands divided from the second input audio signal; and
(ii) when the noise detection signal is affirmed, the noise cancellation circuit performs the noise modification process upon a target modifying frequency band in the plurality of frequency bands of the first input audio signal and the target modifying frequency band of the second input audio signal to generate the third intermediate audio signal, and generates the first intermediate audio signal by combining the third input audio signal and other frequency bands of the first input audio signal, and further generates the second intermediate audio signal by combining the third input audio signal and other frequency bands of the second input audio signal.

5. The audio signal processing circuit of claim 2, wherein:
a target modifying frequency band of the noise cancellation circuit comprises a frequency band of 0˜500 Hz.

6. The audio signal processing circuit of claim 1, wherein:
the noise cancellation circuit performs the noise modification process targeting at all frequency bands of the first input audio signal and the second input audio signal.

7. The audio signal processing circuit of claim 1, wherein:
the noise modification process comprises a process of computing an average value of two target modifying signals.

8. The audio signal processing circuit of claim 7, wherein:
the average value is an unweighted average value of the two target modifying signals.

9. The audio signal processing circuit of claim 7, wherein:
the average value is a weighted average value of the two target modifying signals.

10. The audio signal processing circuit of claim 9, wherein:
a weighting factor for a larger signal in the two target modifying signals is less than the weighting factor for a smaller signal in the two target modifying signals.

11. The audio signal processing circuit of claim 7, wherein:
the noise modification process further comprises at least one of a process of multiplying the two target modifying signals by a specific factor or a process of multiplying the average value by the specific factor.

12. The audio signal processing circuit of claim 11, wherein:
the specific factor is adjusted in accordance with a voltage level of the noise detection signal.

13. An audio signal processing circuit, applicable for processing a first input audio signal and a second input audio signal received from a first microphone and a second microphone respectively, the audio signal processing circuit comprising:
a filter, for dividing the first input audio signal and the second input audio signal into a plurality of frequency bands respectively;
a noise detection circuit, for determining if the first input audio signal and the second input audio signal contain noise higher than a tolerance noise level, wherein when the first input audio signal and the second input audio signal contain the noise, the noise detection circuit detects the noise to generate a noise detection signal; and
a beamforming circuit, wherein (i) when the noise detection signal is negated, the beamforming circuit performs a beamforming process targeting all frequency bands of the first input audio signal and the second input audio signal; (ii) when the noise detection signal is affirmed, the beamforming circuit discards each target modifying frequency band of the first input audio signal and the second input audio signal, and performs the beamforming process upon the remaining frequency bands.

14. The audio signal processing circuit of claim 13, further comprising:
a first amplifier, for amplifying an output signal of the first microphone;
a second amplifier, for amplifying the output signal of the second microphone;
a first analog to digital converter, for converting the output signal of the first amplifier into the first input audio signal in digital format; and
a second analog to digital converter, for converting the output signal of the second amplifier into the second input audio signal in digital format.

15. The audio signal processing circuit of claim 13, which is integrated onto a semiconductor substrate.

16. An electronic device, comprising:
a first channel microphone;
a second channel microphone; and
the audio signal processing circuit of claim 14.

17. An audio signal processing method, applicable for processing a first input audio signal and a second input audio signal received from a first microphone and a second microphone, the audio signal processing method comprising:
determining if the first input audio signal and the second input audio signal contain noise higher than a tolerance noise level;
(i) when the first input audio signal and the second input audio signal are determined to not contain a noise higher than the tolerance noise level, outputting a first intermediate audio signal corresponding to the first input audio signal and a second intermediate audio signal corresponding to the second input audio signal; (ii) when the first input audio signal and the second input audio signal are determined to contain a noise higher than the tolerance noise level, generating a third intermediate audio signal after performing a specific noise modification process upon the first input audio signal and the second input audio signal, and outputting the third intermediate audio signal to be the first intermediate audio signal and the second intermediate audio signal; and
receiving the first intermediate audio signal and the second intermediate audio signal, and performing a beamforming process in accordance with a differential signal between the first intermediate audio signal and the second intermediate audio signal.

18. An audio signal processing method, applicable for processing a first input audio signal and a second input audio signal received from a first microphone and a second microphone, the audio signal processing method comprising:
dividing the first input audio signal and the second input audio signal into a plurality of frequency bands respectively;
determining if the first input audio signal and the second input audio signal contain noise higher than a tolerance noise level;
(i) when the first input audio signal and the second input audio signal are determined to not contain the noise higher than the tolerance noise level, performing a beamforming process targeting all frequency bands of the first input audio signal and the second input audio signal; and
(ii) when the first input audio signal and the second input audio signal are determined to contain the noise higher than the tolerance noise level, discarding each target modifying frequency band of the first input audio signal and the second input audio signal and performing the beamforming process upon the remaining frequency bands.
